(19) United States
(12) Patent Application Publication
(10) Pub. No.: US 2016/0162539 A1
(43) Pub. Date: Jun. 9, 2016

(54) COMPUTER EXECUTABLE METHOD OF GENERATING ANALYSIS DATA AND APPARATUS PERFORMING THE SAME AND STORAGE MEDIUM FOR THE SAME

(71) Applicant: LG CNS CO., LTD., Seoul (KR)

(72) Inventors: Hae Yong YUN, Seoul (KR); Kang Hee Lee, Seoul (KR); Ki Hyun Cho, Seoul (KR); Seong Jin Yoo, Seoul (KR)

(73) Assignee: LG CNS CO., LTD.

(21) Appl. No.: 14/565,163

(22) Filed: Dec. 9, 2014

(51) Int. Cl. G06F 17/30; G06Q 10/06

(52) U.S. Cl. CPC G06F 17/30398; G06F 17/30498; G06F 17/30867; G06Q 10/0633

(57) ABSTRACT

Provided is an analysis data generating method, an apparatus performing the same and a storage medium for the same. A computer executable method of generating analysis data may include receiving an analysis workflow associated with an analysis object, analyzing the received analysis workflow to generate a plurality of query clauses, and combining, using a processor, the plurality of generated query clauses to form a dynamic query. Accordingly, input data for data analysis may be dynamically generated.

### BACKGROUND

1. Field

Embodiments may relate to an analysis data generating technology and more particularly to a computer executable method of generating analysis data, an apparatus performing the same and a storage medium for the same for dynamically generating input data for data analysis.

2. Background

Analysis data generating technologies known. However, they suffer from various disadvantages.

### BRIEF DESCRIPTION OF THE DRAWINGS

The embodiments will be described in detail with reference to the following drawings in which like reference numerals refer to like elements wherein:

FIG. 1 is a block diagram of an analysis data generating apparatus;

FIG. 2 is a flow chart showing an analysis data generating procedure being performed on the analysis data generating apparatus;

FIG. 3 is a block diagram of a hardware configuration of the analysis data generating apparatus;

FIG. 4 is an example diagram showing a first selection screen of an analysis workflow being provided from the analysis data generating apparatus;

FIG. 5 is an example diagram showing a second selection screen of an analysis workflow being provided from the analysis data generating apparatus; and

FIG. 6 is an example diagram showing a third selection screen of an analysis workflow being provided from the analysis data generating apparatus.

### DETAILED DESCRIPTION

Explanation of the present invention is provided through description of various embodiments to facilitate description of structural or functional aspects of the present invention, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps or operations are used for the sake of explanation and do not describe any particular order. The respective operations may be changed from a mentioned order unless specifically mentioned in context. Namely, respective steps may be performed in the same order as described, may be substantially simultaneously performed, or may be performed in reverse order.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

In general, when an analyst generates data for an analysis, there is a difference in time and effort in generating the analysis data according to the programming skill of the analyst. Moreover, the data may have various input form such as a database table, file (e.g., Excel or txt) and XML (eXtensible Markup Language) according to an analysis tool. However, the data is generated by the analyst so that the analyst requires a high level of skill for various high-level forms irrelevant to a format. Therefore, the analyst requires modeling and high level programming skill for generating data. Accordingly, help of a professional programmer is often necessary when generating analysis data.

A multi-tenant support device for dynamically executing and changing the logic of query-based software and a method thereof may be provided to execute an object by dynamically generating software logic, storing the generated information and dynamically loading the information when execution is requested. This technology may provide a base for dynamically generating the software logic, storing the generated information and dynamically loading the information when the execution is requested to make an object and to be executed.

Moreover, a method may be provided for dynamically processing a database using a CORBA platform. This technology may define a general IDL (Interface Definition Language) for a database search at a distributed processing system using the CORBA, decrease a developing range of a developer by dynamically performing a process in a server and decrease a change of an IDL (Interface Definition Language) with respect to a changed transaction request of a client.

As broadly described and embodied herein, provided is a computer executable method of generating analysis data capable of dynamically generating input data for a data analysis. Embodiments may provide a computer executable method of generating analysis data capable of providing a UI (User Interface) associated with analysis data to generate a dynamic query based on an analysis scenario. The computer executable method of generating analysis data capable of providing a UI (User Interface) may enable easily, quickly and accurately generating input data.

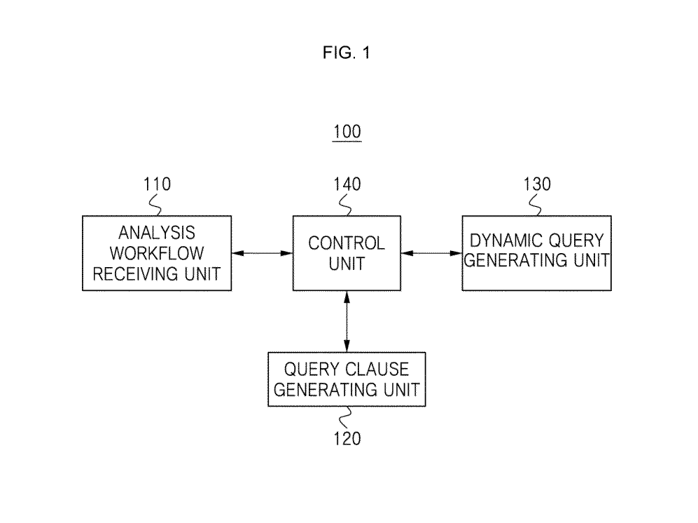

FIG. 1 is a block diagram of an analysis data generating apparatus. The analysis data generating apparatus 100 may include an analysis workflow receiving unit 110, a query clause generating unit 120, a dynamic query generating unit 130 and a control unit 140.

The analysis workflow receiving unit 110 may receive an analysis workflow associated with an analysis object. The analysis object may correspond to data for performing an analysis and may be stored and managed in a database. The analysis workflow may be set based on an analysis scenario, an analysis object data group, a past gathered population data, a current measured population data and a past reference period according to an analysis direction being set by a user. The analysis workflow may be stored and managed in the database with a workflow unit.

The analysis workflow receiving unit 110 may receive an analysis scenario including a pattern analysis method corresponding to at least one of an abnormal pattern analysis group, a relationship analysis group and an effectiveness analysis group. The analysis scenario may include a plurality of analysis patterns indicating a way that analyzes the analysis object. The pattern analysis method may be categorized into the abnormal pattern analysis group, the relationship analysis group and the effectiveness analysis group. Herein, the abnormal pattern analysis group may include a disparateness analysis between the analysis data, the relationship analysis group may include a relationship analysis between the analysis data and the effectiveness analysis group may include an effectiveness analysis between the analysis data.

When the analysis scenario is selected, the analysis workflow receiving unit 110 may provide an analysis object data group associated with the analysis scenario to receive an analysis object sub-data among the analysis object data group from the user. The analysis object data group may correspond to a specific application filed analyzing the analysis object, for example, may include a movement between a product and an agency and a movement between the agency and a customer. The analysis object sub-data may be included in the analysis object data group, for example, may correspond to the movement between the product and an agency and the movement between the agency and the customer.

The analysis workflow receiving unit 110 may receive an analysis table, past gathered population data, current measured population data and a past reference period. The analysis table may correspond to a table being used for the analysis. The past gathered population data may be an object being gathered data and may be set with a plurality of populations and correspond to a column of the analysis table. The past reference period may correspond to a search period of the past gathered population data and may set by a month. The current measured population data may correspond to an object being currently gathered based on the past gathered population data during the past reference period.

In an embodiment, the analysis workflow receiving unit 110 may detect an abnormal pattern for the analysis object sub-data based on the analysis table, the past gathered population data, the current measured population data and the past reference period. When the abnormal pattern is detected in an analysis result, the analysis workflow receiving unit 110 may determine that the analysis object sub-data is abnormal. The analysis workflow receiving unit 110 may digitize and enable visualization of the detected abnormal pattern to generate an analysis result for the analysis object sub-data. The analysis workflow receiving unit 110 may associate the analysis workflow with the analysis result. For example, the abnormal pattern may be implemented as a graph, a table, a figure, or the like.

The query clause generating unit 120 may analyze the received analysis workflow to generate a plurality of query clauses. The plurality of query clauses may be respectively generated through a preset procedure and may be generated as a dynamic query through each of combinations. For example, the plurality of query clauses may be implemented in SQL (Structured Query Language).

The query clause generating unit 120 may search for information for an algorithm associated with the analysis object sub-data. In more detail, the query clause generating unit 120 may search for a key value for the algorithm associated with the analysis object sub-data, check a minimum and maximum number of past gathered population data, a minimum and maximum number of current measured population data and the past reference period to check a compatibility for the analysis object sub-data.

When the compatibility for the analysis object sub-data is not abnormal, the query clause generating unit 120 may generate a WHERE clause in order to determine a range of the analysis object sub-data. In more detail, the query clause generating unit 120 may convert a type of the past reference period according to a preset data type to generate a data range query clause for the analysis object sub-data. For example, the query clause generating unit 120 may convert the past reference period into [yyyy-mm-dd]˜[yyyy-mm-dd] and may convert the past reference period into [2013-10-15]˜[2014-10-15] when the past reference period corresponds to [12] months.

The query clause generating unit 120 may generate a FROM clause in order to define an actual analysis table name for the analysis object sub-data. In more detail, the query clause generating unit 120 may search for a total number of the analysis table associated with the analysis object and check whether the analysis tables are joined to generate a table name query clause defining a table name for the analysis table according to whether the analysis tables are joined. The query clause generating unit 120 may check whether master analysis tables are joined (e.g., when an analysis table storing a master value for the analysis object) in some cases (e.g., in case where there is a master table).

The query clause generating unit 120 may generate a SELECT clause and a GROUP BY clause in reference to the past gathered population data and the current measured population data. In more detail, the number of the past gathered population data and current measured population data may be flexible so that the query clause generating unit 120 may check the number of the past gathered population data and current measured population data and a column alias randomly designated by the user to generate a population query clause. Herein, the query clause generating unit 120 may check whether the column alias is duplicated.

The query clause generating unit 120 may generate the WHERE clause in order to determine a variable and a filtering condition for the algorithm associated with the analysis object sub-data. In more detail, the query clause generating unit 120 may determine a filtering condition for the analysis object sub-data according to a global variable associated with the analysis object to generate a global variable query clause. The query clause generating unit 120 may determine a filtering condition for the analysis object sub-data according to a local variable associated with the analysis object sub-data to generate a local variable query clause. In an embodiment, the query clause generating unit 120 may additionally define information for a generation of a report associated with the analysis workflow. For example, the query clause generating unit 120 may define a number of a month, a frequency number and a weight.

The dynamic query generating unit 130 may combine the plurality of query clauses to complete the dynamic query. The dynamic query may correspond to a language (e.g., SQL) being independently performed. The dynamic query generating unit 130 may combine the plurality of query clauses to be arranged in order of the SELECT clause, the FROM clause, the WHERE clause and the GROUP BY clause.

The dynamic query generating unit 130 may check a compatibility for the dynamic query to determine whether the dynamic query is abnormal. When the dynamic query is not abnormal, the dynamic query generating unit 130 may insert the dynamic query into the algorithm associated with the analysis object sub-data to generate input data.

The control unit 140 may control an overall flow of the analysis data generating apparatus 100 and control an operation and a data flow between the analysis workflow receiving unit 110, the query clause generating unit 120 and the dynamic query generating unit 130.

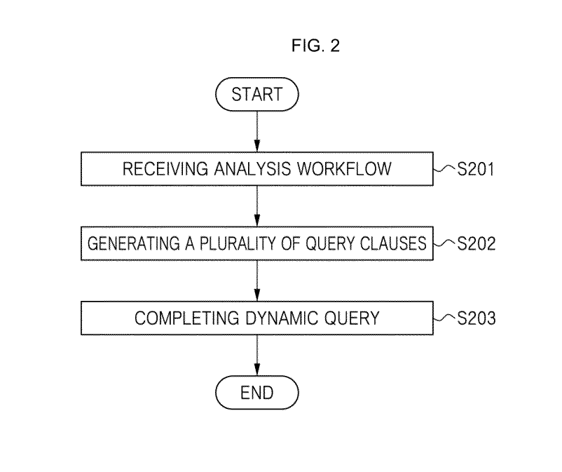

FIG. 2 is a flow chart showing an analysis data generating procedure being performed on the analysis data generating apparatus. The analysis workflow receiving unit 110 may receive the workflow associated with the analysis object, in step S201.

The analysis workflow receiving unit 110 may receive the analysis scenario including the pattern analysis method corresponding to at least one of the abnormal pattern analysis group, the relationship analysis group or the effectiveness analysis group from the user. In an embodiment, the abnormal pattern analysis group may include at least one analysis module where it is suitable to detect an abnormal pattern having a large difference with a mean value compared with a same scale, a pattern change of a specific entity itself, a difference between the pattern change of the specific entity and that of other entities and the abnormal pattern where the data value is extremely biased. In an embodiment, the relationship analysis group may include at least one analysis module where it is suitable to check an important path and to detect a conspiracy or a close relationship among users or entities. In an embodiment, the effectiveness analysis group may include at least one analysis module where it is suitable to perform a verification for an excessive duplication, a non-existence of an actual receiver and a period. It should be appreciated that other types of scenarios for data analysis may also be implemented.

When the analysis scenario is selected, the analysis workflow receiving unit 110 may provide the analysis object data group associated with the analysis scenario to receive the analysis object sub-data among the analysis object data group from the user.

The analysis workflow receiving unit 110 may receive the analysis table, the past gathered population data, the current measured population data and the past reference period for the analysis object sub-data. The analysis workflow receiving unit 110 may detect the abnormal pattern for the analysis object sub-data based on the analysis table, the past gathered population data, the current measured population data and the past reference period.

The query generating unit 120 may analyze the received analysis workflow to generate the plurality of query clauses, in step S202. The query generating unit 120 may search for the information for the algorithm associated with the analysis object sub-data. The query generating unit 120 may generate the WHERE clause (e.g., the data range query clause) to determine a range of the analysis object sub-data when the compatibility for the analysis object sub-data. The query generating unit 120 may generate the FROM clause (e.g., a table name query clause) to define an actual analysis table name for the analysis object sub-data. The query generating unit 120 may generate the SELECT clause and GROUP BY clause in reference to the past gathered population data and the current measured population data. The query generating unit 120 may generate the WHERE clause (e.g., the global variable query clause and the local variable query clause) to determine the variable and the filtering condition for the algorithm associated with the analysis object sub-data.

The dynamic query generating unit 130 may then combine the plurality of query clauses to complete the dynamic query, in step S203. The dynamic query generating unit 130 may combine the plurality of query clauses to be arranged in order of the SELECT clause, the FROM clause, the WHERE clause and the GROUP BY clause.

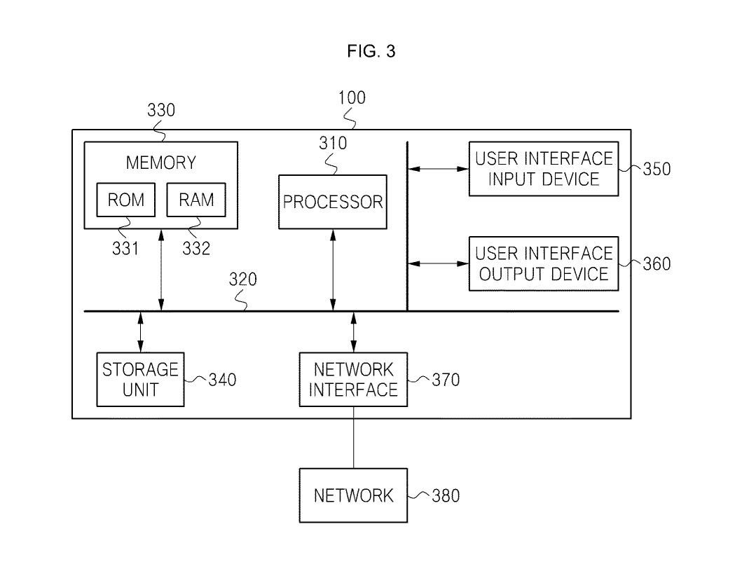

FIG. 3 is a block diagram of a hardware configuration of the analysis data generating apparatus. The analysis data generating apparatus 100 may include a processor 310 or a CPU communicating with various different component through a bus 320. The processor 310 may control an operation of the various different component and execute a management for the various different component and the analysis object. Also, the processor 310 may be electrically connected with the memory 330 to manage the analysis object according to a user's request through commands stored in the memory 330.

The analysis data generating apparatus 100 may include the memory 330 and a storage unit 340. The memory 330 may include ROM (Read Only Memory) 331 and RAM (Random Access Memory) 332. Here, the memory 330 may correspond to a non-transitory or transitory computer readable storage medium and the storage unit 340 may correspond to a non-transitory computer readable storage medium. At least one of the memory 330 and the storage unit 340 may store a computer code including the commands for managing the analysis object.

The analysis data generating apparatus 100 may include a network interface 370 for communicating with a network 380. The network interface 370 may set and provide an environment transmitting information, data and signals between the analysis data generating apparatus 100 and the network 380.

The user may communicate with the analysis data generating apparatus 100 through a user interface/input device 350 (e.g., a mouse, trackball, touch pad, graphic tablet, scanner, barcode scanner for scanning a product barcode, touch screen, keyboard or pointing device). The user interface/input device 350 may include all of the mechanism for inputting information (e.g., a transaction) in the analysis data generating apparatus 100 or the network 380.

The user may receive information (e.g., the analysis object, the analysis object sub-data, the plurality of query clauses and the dynamic query) from the analysis object generating apparatus 100 through a user interface output device 360. The user output device 360 may include a visual output device such as a display screen, but is not limited thereto. The user interface/output device 360 may include various type of devices for outputting information to the user and may be a combination of output devices such as a video display unit and a speaker. In an embodiment, the display screen may display information received from the analysis object generating apparatus 100 and may receive an input from the user. That is, the display screen may be implemented as the user input device 350 as well as the user output device 360.

Components of the analysis object generating apparatus 100 in FIG. 1 may be performed by using components of the analysis object generating apparatus 100 in FIG. 3.

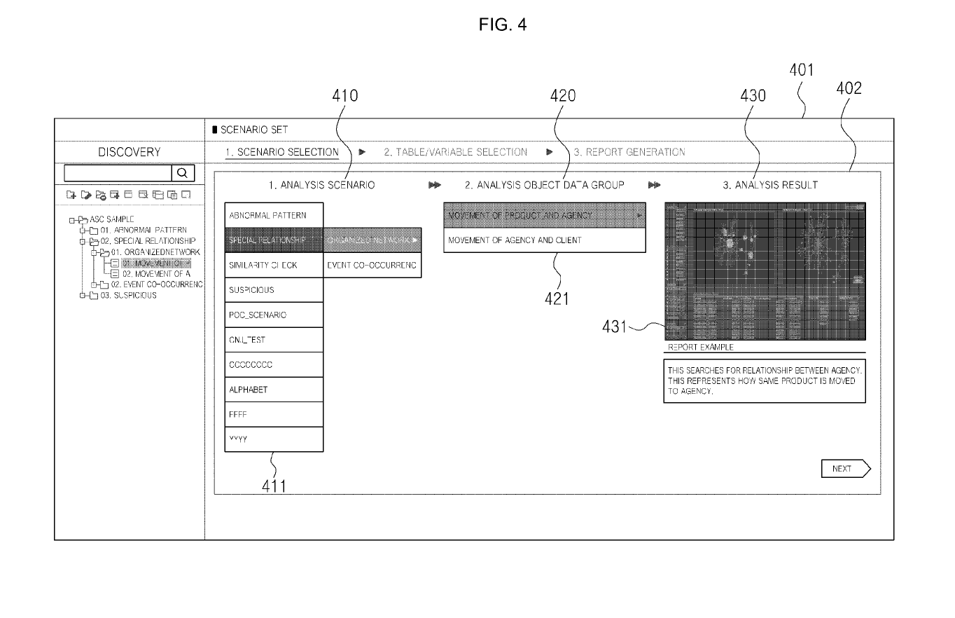

FIG. 4 is a diagram showing a first selection screen of an analysis workflow being provided from the analysis data generating apparatus. The analysis object generating apparatus 100 may display a user interface (UI) on a display 401. The UI interface may include a UI 402 for scenario selection, a UI 502 for Table/Variable selection and a UI 602 for report generation. The UI 402 may include an analysis scenario section 410, an analysis object data group section 420 and an analysis result section 430. A method according to an embodiment of the present disclosure is described in further detail hereinafter.

The analysis object generating apparatus 100 may provide the UI 402 to set the analysis scenario 410 for receiving the analysis workflow from the user. The UI 402 may include the analysis scenario 410 including a plurality of analysis patterns 411 (e.g., Abnormal pattern, Special Relationship, Similarity Check, etc.). The UI 402 may include the analysis object sub-data 421 of the analysis object data group 420 (e.g., a movement between a product and an agency or a movement between the agency and a client) according to the analysis scenario selected by the user. The UI 402 may display a report 431 that provides the abnormal pattern detected based on the analysis table, the past gathered population data, the current measured population data and the past reference period for the analysis object sub-data 421. The report 431 may visually represent the abnormal pattern on the display 401.

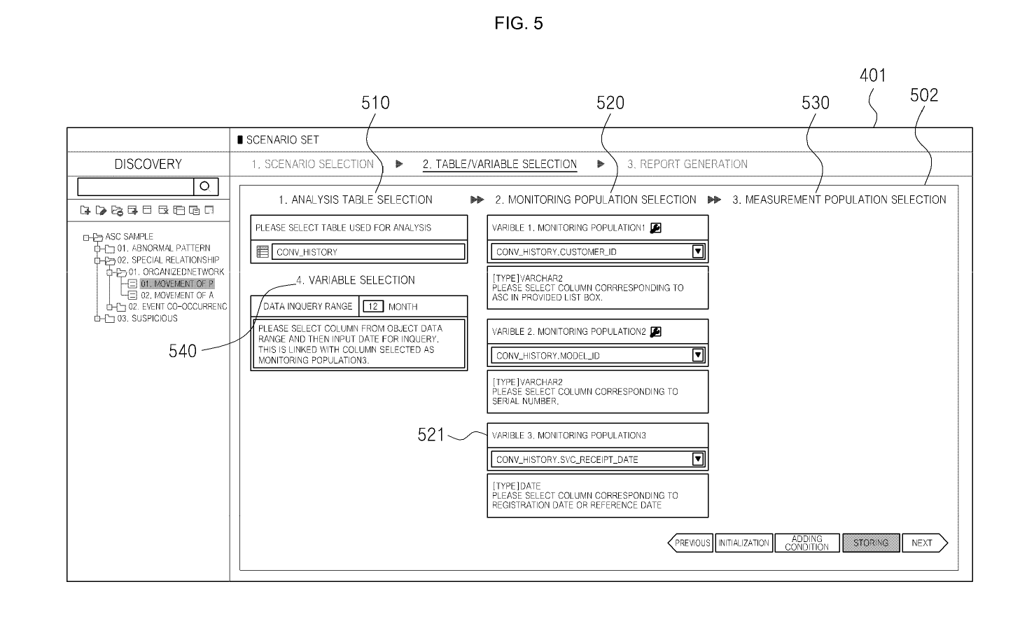

FIG. 5 is a diagram showing a second selection screen of an analysis workflow being provided from the analysis data generating apparatus. The analysis data generating apparatus 100 may provide the UI (User Interface) 502 to set the analysis scenario for receiving the analysis workflow from the user. When the analysis scenario 411 and the analysis object sub-data 421 is selected by the user, UI 503 may provide a list for selecting the analysis table 510, the past gathered population data 520, the current measured population data 530 and the past reference period 540. Here, the past reference period 540 may be coupled with one of the variables of the past gathered population data 521 (e.g., a past gathered population 3).

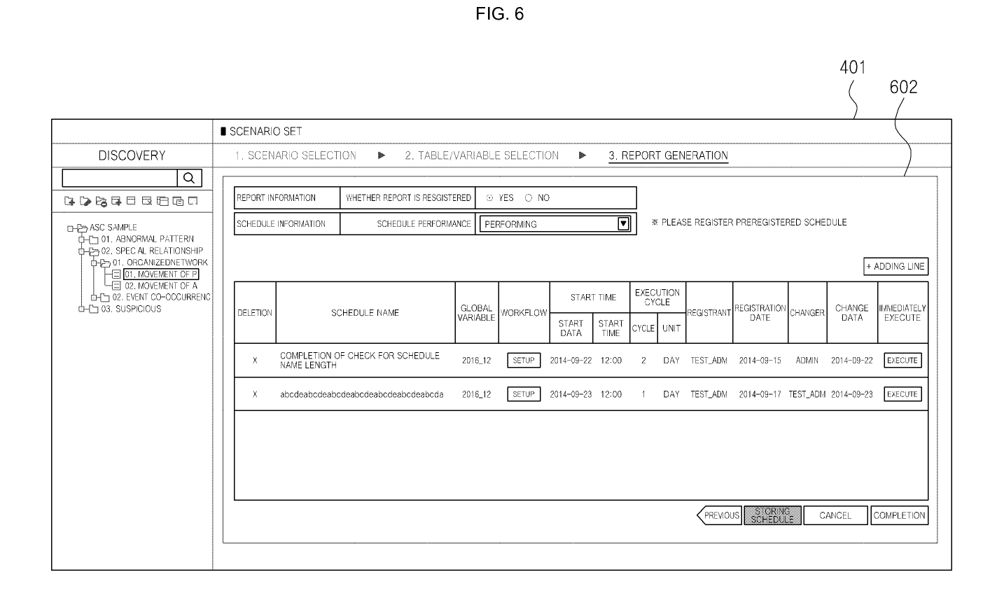

FIG. 6 is a diagram showing a third selection screen of an analysis workflow being provided from the analysis data generating apparatus. The analysis data generating apparatus 100 may provide a UI (User Interface) 602 including information for a report associated with the analysis workflow received from the user. The UI may provide report information (whether the report is registered) or schedule information (whether a schedule is performed) to manage the schedule for the analysis workflow by the user.

As broadly described and embodied herein, provided is a computer executable method of generating analysis data capable of dynamically generating input data for a data analysis. Embodiments may provide a computer executable method of generating analysis data capable of providing a UI (User Interface) associated with analysis data to generate a dynamic query based on an analysis scenario. The computer executable method of generating analysis data capable of providing a UI (User Interface) may enable easily, quickly and accurately generating input data.

In at least one embodiment, an analysis data generating method may include receiving an analysis workflow associated with an analysis object, analyzing the received analysis workflow to generate a plurality of query clauses and combining the plurality of generated query clauses to complete a dynamic query.

Receiving the analysis workflow associated with the analysis object may include receiving an analysis scenario from a user. Receiving the analysis workflow associated with the analysis object may include receiving analysis object sub-data among an analysis object data group associated with the analysis scenario from the user.

Receiving the analysis workflow associated with the analysis object includes receiving an analysis table, a past gathered population data, a current measured population data and a past reference period for the analysis object sub-data.

In at least one embodiment, receiving the analysis workflow associated with the analysis object may include detecting an abnormal pattern for the analysis object sub-data based on the analysis table, the past gathered population data, the current measured population data and the past reference period.

Receiving the analysis workflow associated with the analysis object may include visualizing the detected abnormal pattern to associating the visualized abnormal pattern with the analysis workflow.

In at least one embodiment, analyzing the received analysis workflow may include searching for a key value for an algorithm associated with the analysis object sub-data, checking a minimum and maximum number of each of the past gathered population data and current measured population data and checking the past reference period to check a compatibility for the analysis object sub-data.

Analyzing the received analysis workflow may include converting a type of the past reference period according to a preset data type to generate a data range query clause for the analysis object sub-data.

Analyzing the received analysis workflow may include checking whether the analysis tables are joined to generate a table name query clause defining a table name for the analysis table according to whether the analysis tables are joined.

In at least one embodiment, analyzing the received analysis workflow may include respectively checking a number of the past gathered population data and the current measured population data to generate a population query clause.

Analyzing the received analysis workflow may include determining a filtering condition for the analysis object sub-data according to a global variable associated with the analysis object to generate a global variable query clause.

Analyzing the received analysis workflow may include determining a filtering condition for the analysis object sub-data according to a local variable associated with the analysis object to generate a local variable query clause.

In at least one embodiment, combining the plurality of generated query clauses may include arranging the plurality of generated query clauses in order of a SELECT clause, a FROM clause, a WHERE clause and a GROUP BY clause to combine the plurality of arranged query clauses.

Combining the plurality of generated query clauses may include checking a compatibility for the dynamic query to determine whether the dynamic query is abnormal.

In at least one embodiment, combining the plurality of generated query clauses may include inserting the dynamic query into an algorithm associated with the analysis object sub-data when the dynamic query is not abnormal to generate input data.

In at least one embodiment, an analysis data generating apparatus includes a processor, a memory including at least one storage space and a non-transitory computer-readable medium including commands causing the processor to perform a following method when the processor is executed and the method includes receiving an analysis workflow associated with an analysis object, analyzing the received analysis workflow to generate a plurality of query clauses and combining the plurality of generated query clauses to completing a dynamic query.

In at least one embodiment, a computer-readable storage medium recording a computer program for implementing an analysis data generating method and the method includes a function to receive an analysis workflow associated with an analysis object, a function to analyze the received analysis workflow to generate a plurality of query clauses and a function to combine the plurality of generated query clauses to completing a dynamic query.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computer executable method of generating analysis data according to embodiments may dynamically generate input data for a data analysis.

A computer executable method of generating analysis data according to embodiments may provide a UI (User Interface) associated with analysis data to generate a dynamic query based on an analysis scenario.

A computer executable method of generating analysis data according to embodiments may provide a UI (User Interface) for easily, quick and accurately generating input data.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A computer executable method of generating analysis data, the method comprising:
receiving an analysis workflow associated with an analysis object;
analyzing the received analysis workflow to generate a plurality of query clauses; and
combining, using a processor, the plurality of generated query clauses to form a dynamic query.

2. The method of claim 1, wherein receiving the analysis workflow associated with the analysis object includes receiving an analysis scenario through a user interface.

3. The method of claim 2, wherein receiving the analysis workflow associated with the analysis object includes receiving a selection for analysis object sub-data among an analysis object data group associated with the analysis scenario through the user interface.

4. The method of claim 3, wherein receiving the analysis workflow associated with the analysis object includes receiving selections for an analysis table, a past gathered population data, a current measured population data and a past reference period for the selected analysis object sub-data.

5. The method of claim 4, wherein receiving the analysis workflow associated with the analysis object includes detecting an abnormal pattern for the analysis object sub-data based on the analysis table, the past gathered population data, the current measured population data and the past reference period.

6. The method of claim 5, wherein receiving the analysis workflow associated with the analysis object includes displaying the detected abnormal pattern such that the detected abnormal pattern is visually associated with the analysis workflow.

7. The method of claim 4, wherein analyzing the received analysis workflow includes searching for a key value for an algorithm associated with the analysis object sub-data, checking a minimum and maximum number of each of the past gathered population data and current measured population data, and checking the past reference period to check a compatibility of the analysis object sub-data.

8. The method of claim 4, wherein analyzing the received analysis workflow includes converting a type of the past reference period according to a preset data type to generate a data range query clause for the analysis object sub-data.

9. The method of claim 4, wherein analyzing the received analysis workflow includes checking whether the analysis tables are joined to generate a table name query clause to define a table name for the analysis table according to whether the analysis tables are joined.

10. The method of claim 4, wherein analyzing the received analysis workflow includes respectively checking a number of the past gathered population data and the current measured population data to generate a population query clause.

11. The method of claim 4, wherein analyzing the received analysis workflow includes determining a filtering condition for the analysis object sub-data according to a global variable associated with the analysis object to generate a global variable query clause.

12. The method of claim 4, wherein analyzing the received analysis workflow includes determining a filtering condition for the analysis object sub-data according to a local variable associated with the analysis object to generate a local variable query clause.

13. The method of claim 1, wherein combining the plurality of generated query clauses includes arranging the plurality of generated query clauses in order of a SELECT clause, a FROM clause, a WHERE clause, and a GROUP BY clause to combine the plurality of arranged query clauses.

14. The method of claim 1, wherein combining the plurality of generated query clauses includes checking a compatibility of the dynamic query to determine whether the dynamic query is abnormal.

15. The method of claim 14, wherein combining the plurality of generated query clauses includes inserting the dynamic query into an algorithm associated with the analysis object sub-data when the dynamic query is not abnormal to generate input data.

16. An analysis data generating apparatus comprising:
a processor;
a memory including at least one storage space; and
a non-transitory computer-readable medium including commands causing the processor to perform a method when the processor is executed, the method comprising:
receiving an analysis workflow associated with an analysis object;
analyzing the received analysis workflow to generate a plurality of query clauses; and
combining the plurality of generated query clauses to completing a dynamic query.

17. A computer-readable storage medium having stored thereon a computer program for implementing an analysis data generating method comprising:
a function to receive an analysis workflow associated with an analysis object;
a function to analyze the received analysis workflow to generate a plurality of query clauses; and
a function to combine the plurality of generated query clauses to completing a dynamic query.
